(19) United States
(12) Patent Application Publication
(10) Pub. No.: US 2007/0063489 A1
(43) Pub. Date: Mar. 22, 2007

(54) Quick connect airbag coupling

(75) Inventors: Paul Dinsdale, Farr West, UT (US); Scott Jackson, Centerville, UT (US)

Correspondence Address: Sally J. Brown;AUTOLIV ASP, INC., 3350 Airport Road, Ogden, UT, 84405, US

(73) Assignee: Autoliv ASP, Inc.

(21) Appl. No.: 11/231,148

(22) Filed: Sep. 20, 2005

(51) Int. Cl. B60R 21/16

(52) U.S. Cl. 280/728.2

(57) ABSTRACT

An airbag module may have an inflator and a cushion that are coupled together via first and second retention features. The first retention feature may be a clip seated within a housing coupled to the inflator or the cushion, and may have a tubular shape with inwardly extending fingers. The second retention feature may be a flared tubular end insertable into interlocking engagement with the first retention feature. The retention features may be used to couple the cushion or inflator to a gas guide, or to couple the inflator directly-to an inflation tube attached to the fabric of the cushion. The retention features may also be used to couple a transportation cap to the inflator to disperse inflation gases along a thrust neutral pattern in the event of accidental discharge during shipping.

### BACKGROUND OF THE INVENTION

The inclusion of inflatable safety restraint devices, or airbags, is now a legal requirement for many new vehicles. Airbags are typically installed in the steering wheel and in the dashboard on the passenger's side of a car. Additionally, airbags may be installed to inflate beside vehicle occupants to provide side impact protection, in front of the knees to protect the knees from impact, or at other strategic locations. Side impact airbags known as “inflatable curtains” may deploy downward from the roof to protect vehicle occupants from lateral impacts and/or rollover injury.

In the event of an accident, a sensor system within the vehicle senses an impact situation and triggers the ignition of an inflator. Inflation gases from the inflator fill the airbag cushions, which immediately inflate to protect the driver and/or passengers from impact against the interior surfaces of the vehicle. During normal vehicle operation, airbags are typically stowed behind covers to protect them from tampering and provide a more attractive interior facade for the vehicle.

In some airbag modules, the inflator is positioned inside the cushion. However, in many airbag modules, the inflator is outside the cushion, and the inflator must be coupled to the cushion, either directly or via a conduit such as a “gas guide.” Many airbag modules utilize crimped connections to couple the inflator to the cushion or gas guide. Crimping requires specialized tooling to obtain the pressures needed for material deformation. Additionally the crimping operation adds to the total time required to assemble the module, and therefore adds significantly to the overall module cost. Many airbag modules are assembled prior to installation in the automobile. Unfortunately, a fully assembled airbag module is more difficult to ship, and reduces the flexibility of the vehicle assembly process.

Furthermore, the use of “axial” inflators, or inflators that eject gas directly along their axis, can provide cost savings and/or expedite inflation in certain airbag modules such as inflatable curtains. Axial inflators must generally be shipped in such a manner that any accidental gas release is “thrust neutral,” and is thus unlikely to cause significant motion of the inflator. Accordingly, transportation caps must often be coupled to axial inflators to divert axially ejected gases to neutralize the resulting thrust. As known in the art, transportation caps may be coupled via crimping, fastening, or other known methods. Such methods require extra hardware and assembly time at the shipping end, and also require disassembly time at the receiving end, where the transportation caps are removed to permit installation of the inflator in the vehicle.

### BRIEF SUMMARY OF THE INVENTION

The apparatus and method of the present invention have been developed in response to the present state of the art, and in particular, in response to the problems and needs in the art that have not yet been fully solved by currently available airbag modules. Thus, it is an overall objective of the present invention to provide an airbag module and associated connection systems and methods that remedy the shortcomings of the prior art.

According to one embodiment, the invention may be applied to an inflatable curtain module, or IC module, with an inflatable cushion configured to activate to shield a vehicle occupant from impact against a lateral surface of the vehicle, such as a door or window. The cushion preferably has at least one protection zone, and may optionally have multiple protection zones, each of which may serve to protect one occupant. Thus, a single cushion may, for example, cover a rear door or surface as well as a front door, so that an occupant of a back seat can be protected as well as an occupant of a front seat. The protection zones may be connected by a central tether configured to convey tension and inflation gas between the protection zones.

The IC module also has an inflator connected to the cushion via a quick-connect coupling. The cushion may have an inflation tube to which the inflator is connected by the quick-connect coupling such that inflation gas is able to flow from the inflator directly into the inflation tube. The inflator is controlled by an electronic control unit (ECU) coupled to an accelerometer that reads the acceleration of the vehicle and transmits an activation signal to trigger deployment of the inflator when a collision is detected.

The inflator may have an inflator chamber containing a pressurized gas, a pyrotechnic, or both. The quick-connect coupling may include a housing attached directly to the inflator chamber such that inflation gas exiting the inflator chamber passes through the housing. The housing may have a generally tubular shape with an orifice through which inflation gas enters the housing, a shoulder attached to the inflator chamber, and a retention lip.

In addition to the housing, the quick-connect coupling may include a diffuser, a screen, an o-ring, and a first retention feature in the form of a clip seated in the housing. The clip may have a generally tubular shape, with inwardly-extending fingers. The diffuser may have a shoulder that sandwiches the o-ring against the interior of the shoulder of the housing to prevent gas leakage. The diffuser also has a passageway through which the inflation gas travels, and an outflow cap with a plurality of radially-oriented orifices that release inflation gas into the inflation tube of the cushion. The screen is positioned within the outflow cap to restrict the escape of solid material from the inflator.

The inflation tube has an end retained within an inlet port of the cushion, and a second retention feature in the form of a flared tubular end. The flared tubular end may be inserted into the housing such that the flared tubular end passes through the lip and through the clip to spread the fingers outward. The flared tubular end then abuts the shoulder of the diffuser, and as the flared tubular end is pressed against the shoulder, the o-ring is compressed and the flared tubular end passes beyond the ends of the fingers. The deflection of the fingers is relieved as the ends of the fingers are able to move inward again, and the fingers then block withdrawal of the flared tubular end of the inflation tube from the housing. Accordingly, assembly of the airbag module is easily accomplished by inserting the flared tubular end into engagement with the quick-connect coupling. No tooling is required. The o-ring restricts gas leakage from the quick-connect coupling.

The inflator chamber may be manufactured according to known methods. The housing, diffuser, and clip may be manufactured via cold heading, stamping, rolling, and/or other known methods. The clip need not extend full-circle, but may only extend about an angle approaching 360 degrees. Thus, the clip may be stamped in flat form, and then rolled into the desired shape. The housing may be inertially welded to the inflator chamber, and the o-ring, diffuser, and clip may then be inserted into the housing. The cushion, including the fabric portion and the inflation tube, may be manufactured according to known methods. The inflation tube may be retained within the inlet port of the cushion via a clamp that encircles the inlet port.

According to one alternative embodiment of the invention, an airbag module again has an inflator and a cushion. Additionally, a gas guide connects the inflator to the inflation tube of the cushion. A quick-connect coupling similar to that of the previous embodiment is attached to the inflation tube, not the inflator chamber. One end of the gas guide is attached to the inflator via crimping, and the other end has a flared tubular shape. The flared tubular end is engaged by the quick-connect coupling.

As in the previous embodiment, the quick-connect coupling includes a housing, a clip, and an o-ring. However, a diffuser is not part of the quick-connect coupling, but is instead fixedly attached to the inflator. The inflator has an end plate inertially welded to the inflator chamber, and the diffuser is crimped to the end plate. The gas guide has an end that is also crimped to the end plate. The gas guide also has a flared tubular end like that of the inflation tube of the previous embodiment. The clip is retained within the housing, and the o-ring is also disposed within the housing.

When the flared tubular end is inserted into the flared tubular end, the fingers of the clip are spread outward in a manner similar to that of the previous embodiment. The flared tubular end moves past the fingers as the flared tubular end compresses the o-ring directly. The fingers snap back inward to block withdrawal of the flared tubular end. The o-ring restricts gas leakage from the quick-connect coupling. The various parts of the airbag module may be manufactured according to methods similar to those set forth previously, in connection with the previous embodiment. The inflator and the gas guide may be crimped together prior to or after the airbag module is shipped.

According to another alternative embodiment of the invention, an airbag module may have an inflator, a cushion, and a gas guide. The inflator and the cushion may be coupled to the gas guide via two quick-connect couplings. The inflator may have a configuration similar to that of the first embodiment. More precisely, the inflator may have an inflator chamber attached to a quick-connect coupling via inertial welding or the like. The quick-connect coupling may have a housing containing a clip, an o-ring, a diffuser, and a screen. The housing, clip, and o-ring may be configured in a manner similar to those of the first embodiment. However, the diffuser may have orifices oriented axially, rather than radially.

A second quick-connect coupling may be attached to an inflation tube of the cushion. The second quick-connect coupling may be configured similarly to the quick-connect coupling of the previous embodiment. Thus, the second quick-connect coupling also has a housing, a clip, and an o-ring. The gas guide has two flared tubular ends, each of which is insertable into one of the quick-connect couplings.

Each quick-connect coupling may operate in a manner similar to those of the previous embodiments. More precisely, each flared tubular end slides into the corresponding housing to spread the fingers of the corresponding clip outward. The o-rings are compressed as the flared tubular ends slide past the ends of the fingers and the ends of the fingers are once again permitted to move inward. The flared tubular ends are then retained by the fingers, and the o-rings restrict gas leakage from the quick-connect couplings.

Since the airbag, inflator, and gas guide are all connectable via the quick-connect couplings, they may be shipped separately and easily connected together after shipping. Accordingly, each component may be individually installed in the vehicle and connected to the remaining components. The various parts of the airbag module may be manufactured according to a variety of methods, as set forth in connection with the first embodiment.

The diffuser of the inflator has axially oriented orifices, and therefore may provide expedited inflation and/or cost benefits for airbags such as inflatable curtains. A transportation cap may be coupled to the inflator to divert any escaping gases in radial directions to make the inflator thrust-neutral. Thus, the inflator may be shipped without risking acceleration of the inflator in response to accidental deployment. The transportation cap and inflator, combined, form an inflation assembly.

The transportation cap may have a flared tubular end like that of the gas guide, and may thus be connectable to the quick-connect coupling in a manner similar to that of the previous embodiment. The transportation cap may also have a plurality of orifices oriented radially to disperse gas from the inflator chamber in a thrust-neutral manner.

Through the use of the airbag modules and associated methods of the present invention, airbag modules may be easily and economically manufactured, shipped, and assembled. Additionally, airbag module components may be easily coupled together without tooling. Thus, there is considerable flexibility in where the components are placed and how they are assembled. These and other features and advantages of the present invention will become more fully apparent from the following description and appended claims, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is perspective view of an airbag module according to one embodiment of the invention, installed in a vehicle;

FIG. 2 is a side elevation, section view of a portion of the airbag module of FIG. 1;

FIG. 3 is a side elevation, section view of a portion of an airbag module according to one alternative embodiment of the invention

FIG. 4 is a side elevation, section view of a portion of an airbag module according to another alternative embodiment of the invention; and

FIG. 5 is a side elevation, section view of an inflation assembly including the inflator of the airbag module of FIG. 4, and a transportation cap coupled to the inflator to disperse any gases released by the inflator in a thrust neutral manner.

### DETAILED DESCRIPTION OF THE INVENTION

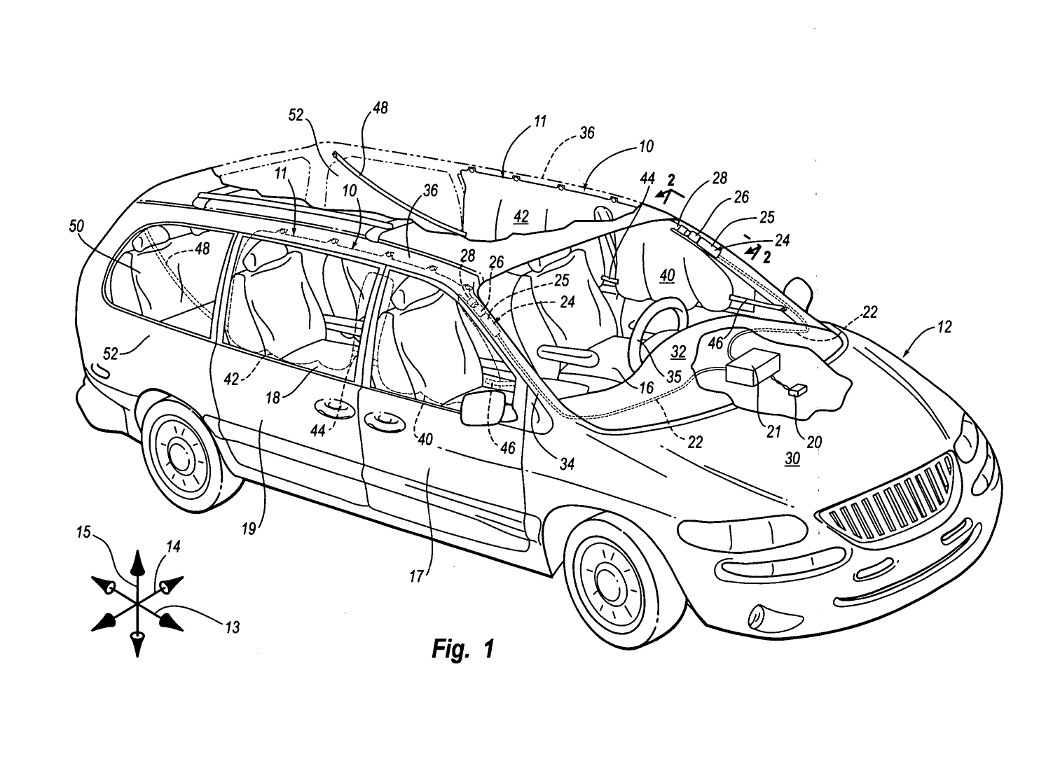

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 5, is not intended to limit the scope of the invention, as claimed, but is merely representative of presently preferred embodiments of the invention.

For this application, the phrases “connected to,” “coupled to,” and “in communication with” refer to any form of interaction between two or more entities, including mechanical, electrical, magnetic, electromagnetic, and thermal interaction. The phrase “attached to” refers to a form of mechanical coupling that restricts relative translation or rotation between the attached objects. The phrases “pivotally attached to” and “slidably attached to” refer to forms of mechanical coupling that permit relative rotation or relative translation, respectively, while restricting other relative motion.

The phrase “attached directly to” refers to a form of attachment by which the attached items are either in direct contact, or are only separated by a single fastener, adhesive, chemical bond, or other attachment mechanism. The term “abutting” refers to items that are in direct physical contact with each other, although the items may not be attached together. The term “grip” refers to items that are in direct physical contact with each other, wherein one item holds the other firmly. The terms “integrally formed” refer to a body that is manufactured integrally, i.e., as a single piece, without requiring the assembly of multiple pieces. Multiple parts may be integrally formed with each other if they are formed from a single workpiece. Items that are “coupled to” each other may be formed as a single piece with each other.

Referring to FIG. 1, a perspective view illustrates two inflatable curtain modules 10, or IC modules 10, according to one possible embodiment the invention. Each of the IC modules includes a cushion 11 designed to inflate to protect an occupant of a vehicle 12 in which the IC modules 10 are installed. The IC modules 10 are designed to protect the occupant from lateral impact; however, the present invention applies to other types of airbag systems such as driver's and passenger's side front impact airbags, overhead airbags, and knee bolsters. Use of side impact airbags is purely exemplary.

The vehicle 12 has a longitudinal direction 13, a lateral direction 14, and a transverse direction 15. The vehicle 12 further has front seats 16 laterally displaced from first lateral surfaces 17, or front doors 17, as shown in the vehicle 12 of FIG. 1. The vehicle 12 also has rear seats 18 laterally displaced from second lateral surfaces 19, or rear doors 19, as depicted.

An accelerometer 20 or other similar impact sensing devices detect sudden lateral acceleration (or deceleration) of the vehicle 12. The accelerometer 20 is coupled to an electronic control unit, or ECU 21. The ECU 21 processes output from the accelerometer 20 and transmits electric signals via electric lines 22 to inflators 24 disposed to inflate each of the cushions 11. In alternative embodiments, a single inflator 24 may be coupled to both of the cushions 11 via gas guides or other structures in such a manner that the inflator 24 inflates both of the cushions 11.

Each of the inflators 24 is designed to release inflation gas upon application of electricity to inflate the corresponding cushion 11. The inflators 24 may operate with such rapidity that, before the vehicle 12 has fully reacted to the impact, the cushions 11 have inflated to protect vehicle occupants from impact. Each inflator 24 has an inflator chamber from which the inflation gas is released, and a quick-connect coupling 26 that facilitates attachment of the inflator 24 with an inflation conduit in the form of an inflation tube 28 of the corresponding cushion 11. The inflation tube 28 is a rigid tubular structure attached directly to the fabric of the cushion 11 to convey inflation gas directly into the cushion 11. In alternative embodiments, inflation conduits need not be tubular, and need not be attached directly to cushion fabrics, and may comprise alternative structures such as gas guides.

The accelerometer 20 and the ECU 21 may be disposed within an engine compartment 30 or dashboard 32 of the vehicle 12. In such a configuration, the electric lines 22 may be disposed along A pillars 34 of the vehicle 12 to convey electricity from the vicinity of the dashboard 32 upward, along the windshield 35, to the inflators 24. The accelerometer 20, ECU 21, and the inflators 24 need not be positioned as shown, but may be disposed at a variety of locations within the vehicle 12. The ECU 21 may include capacitors or other devices designed to provide a sudden, reliable burst of electrical energy.

Each of the cushions 11 is installed along one of the roof rails 36. The cushions 11 shown in FIG. 1 are configured to protect not only occupants of the front seats 16, but those of the rear seats 18 as well. Thus, each cushion 11 may have a first protection zone 40 configured to inflate between the front seats 16 and one of the front doors 17, and a second protection zone 42 configured to inflate between the rear seats 18 and one of the rear doors 19.

The first and second protection zones 40, 42 of each cushion 11 may be coupled together through the use of a central tether 44 between the protection zones 40, 42. The central tethers 44 may be longitudinally positioned between the front seats 16 and the rear seats 18; consequently, the central tethers 44 may or may not be configured to provide impact protection for occupants of the vehicle 12. If desired, the central tethers 44 may be replaced by broader fabric sections and/or additional inflatable chambers (not shown).

The first protection zone 40 of each cushion 11 may be coupled to the adjoining A pillar 34 via a front tether 46. Similarly, the second protection zone 42 of each cushion 11 may be coupled to the rearward portion of the adjoining roof rail 36 via a rear tether 48. The front and rear tethers 46, 48 cooperate with the central tether 44 to provide a tension line across each cushion 11 to keep the cushions 11 in place during inflation and impact.

Although each cushion 11 in FIG. 1 has two protection zones 40, 42, the invention encompasses the use of cushions with any number of protection zones. Thus, if desired, the protection zones 42 and central tethers 44 may be omitted to leave only the protection zones 40. Alternatively, each of the cushions 11 may be extended to have one or more protection zones positioned to protect occupants of extra seats 50 behind the rear seats 18 from impact against third lateral surfaces 52 of the vehicle 12.

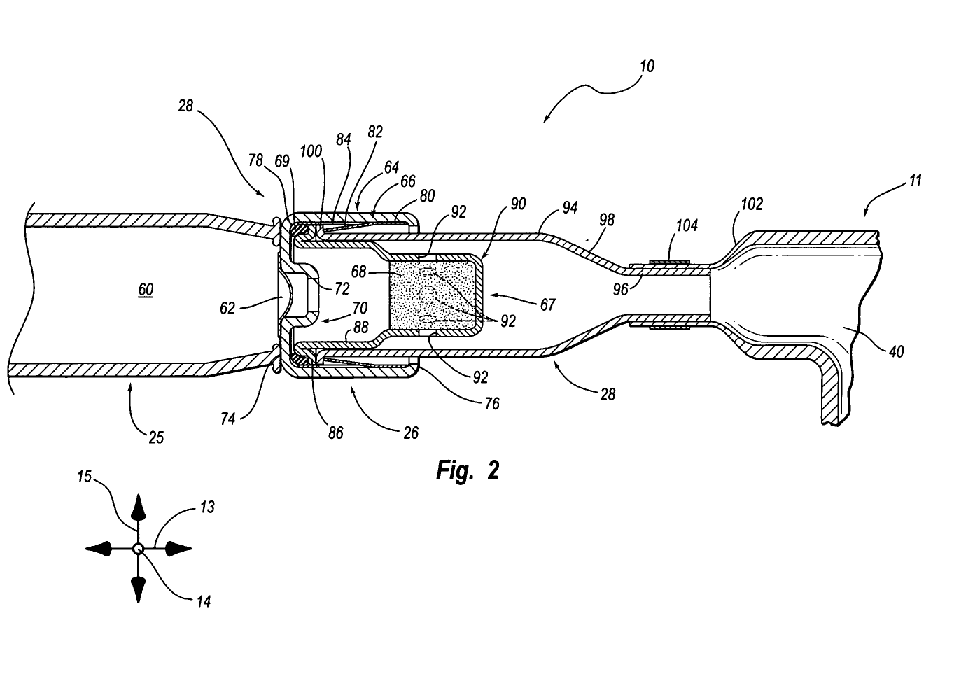

The airbag modules 10 of FIG. 1 are easy to assemble due to the presence of the quick-connect couplings 26. The configuration of the quick-connect couplings 26, and the manner in which they are attached to the inflation tubes 28, will be set forth in greater detail in connection with FIG. 2.

Referring to FIG. 2, a side elevation, section view illustrates a portion of the airbag module 10 of FIG. 1. More precisely, FIG. 2 illustrates a portion of the cushion 11, including the inflation tube 28, and a portion of the inflator 24, including the quick-connect coupling 26. As in FIG. 1, the quick-connect coupling 26 is shown coupled to the inflation tube 28.

As illustrated, the inflator chamber 25 has an interior 60 that may be filled with a compressed gas, liquid/gas mixture, or the like. Since the inflator 24 may be a compressed gas inflator, a pyrotechnic inflator, or a hybrid inflator, a pyrotechnic (not shown) may additionally or alternatively be present within the interior 60. Compressed gas within the interior 60 may be through the use of a burst disc 62 designed to maintain a seal until the inflator 24 deploys.

The quick-connect coupling 26 may have a housing 64 with a generally tubular shape that retains the various other components of the quick-connect coupling 26. In addition to the housing 64, the quick-connect coupling 26 has a first retention feature designed to retain the inflation tube 28. In FIG. 2, the first retention feature takes the form of a clip 66 with a generally tubular configuration. Additionally, the quick-connect coupling 26 includes a diffuser 67, a screen 68, and an o-ring 69.

The housing 64 may be formed of a metal such as steel, aluminum, alloys thereof, and the like. It may be advantageous to construct the housing 64 of a material similar to that of the inflator chamber 25 to facilitate attachment of the housing 64 to the inflator chamber 25. The housing 64 has an indentation 70 that extends into the interior of the housing 64 from proximate the inflator chamber 25. The burst disc 62 may be seated in the exterior of the indentation 70. The indentation 70 has an orifice 72 through which inflation gas is able to enter the remainder of the housing 64 from within the indentation 70. The indentation 70 extends from a shoulder 74 that is directly attached to the inflator chamber 25 via inertial welding or the like. The housing 64 also has a retention lip 76 that extends inward to retain the clip 66, and thence, the end of the inflation tube 28.

The clip 66 may be formed of a variety of metals, including steel, aluminum, brass, copper, and the like. The clip 66 may have a generally tubular shape formed by rolling a generally flat piece of metal about an angle approaching full-circle. The clip 66 may extend about an angle of about 340° or 350°, and may thus have a generally tubular, or annular, shape. The clip 66 has a first annular portion 78 positioned adjacent to the shoulder 74 and a second annular portion 80 positioned adjacent to the retention lip 76. The phrase “annular portion” is used loosely herein to include shapes that do not extend full-circle, but nonetheless define a generally ring-like shape.

The clip 66 also has a plurality of fingers 82 extending form the second annular portion 80 generally toward the first annular portion 78. The fingers 82 are not connected to the first annular portion 78, but are instead angled inward with respect to the axis of symmetry of the inflator 24. The fingers 82 are arranged in generally symmetrical fashion about the circumference of the clip 66. The first and second annular portions 78, 80 are attached together via connecting portions 84 that extend along the longitudinal direction 13. One of the connecting portions 84 is positioned between each pair of adjacent fingers 82.

In alternative embodiments of the invention, a first retention feature may have a configuration different from that of the clip 66. Any structure that is easily positioned to retain another structure may be used. Accordingly, the phrase “retention feature,” in this application, refers to any of a wide variety of clips, clamps, hooks, flanges, snaps, and other fastening devices.

Returning to FIG. 2, the diffuser 67 also has a shoulder 86, which is positioned such that the o-ring 69 is sandwiched between the shoulder 86 and the shoulder 74 of the housing 64. The shoulder 86 extends outward to contact, or nearly contact, the interior surface of the first annular portion 78 of the clip 66. The diffuser 67 also has a passageway 88 that encircles the indentation 70 of the housing 64 and receives inflation gas exiting the indentation 70 via the orifice 72. The passageway 88 conducts the inflation gas to an outflow cap 90, which may extend longitudinally beyond the retention lip 76 of the housing 64. The outflow cap 90 has a plurality of orifices 92 oriented generally radially such that inflation gas is expelled from the outflow cap 90 generally within the plane defined by the lateral and transverse directions 14, 15. Thus, the inflator 24 provides radial, thrust neutral gas flow into the inflation tube 28.

If desired, the orifices 92 may provide a collective flow area larger than the flow area provided by the orifice 72 of the indentation 70 of the housing 26. Thus, the size of the orifice 72 may determine the rate at which inflation gas is able to exit the inflator 24. Alternatively, the orifices 92 may provide a collective flow area larger than that of the orifice 72 so that the orifices 92 limit the flow rate of inflation gas from the inflator 24.

The inflation tube 28 of the cushion 11 may have a larger portion 94 retained by the quick-connect coupling 26, and a smaller portion 96 attached directly to the fabric of which the remainder of the cushion 11 is constructed. A taper 98 is positioned between the larger portion 94 and the smaller portion 96 to provide a relatively gradual size change. The inflation tube 28 has a second retention feature designed to interlock with the quick-connect coupling 26, and more specifically, with the first retention feature, i.e., the clip 66. In the embodiment of FIG. 2, the second retention feature takes the form of a flared tubular end 100 of the inflation tube 28. In this application, “flared” does not require a tapered shape, but includes a structure such as a flange extending outward, perpendicular to the surface to which it is connected. The term “flared” also does not require the use of a feature that is unitarily formed with the remainder of the inflation tube 28.

The opposite end of the inflation tube 28, i.e., the smaller portion 96, is gripped directly within an inlet port 102 of the cushion 11 by a clamp 104 that encircles, or substantially encircles, the inlet port 102. The clamp 104 may be a tightly fitted metal band that compresses the fabric of the inlet port 102 around the smaller portion 96 to keep the inflation tube 82 securely attached to the remainder of the cushion 11.

The flared tubular end 100 extends outward to a maximum diameter similar to that of the shoulder 86 of the diffuser 67. The flared tubular end 100 is sized to be insertable along the longitudinal direction 13 into the housing 64 through the opening defined by the retention lip 76. Like the first retention feature, the second retention feature may have a variety of alternative configurations different from the flared tubular end 100. In alternative embodiments, an inflation conduit according to the invention may have a second retention feature that is not integrally formed with the conduit, but is rather a separate piece coupled to the inflation conduit. The flared tubular end 100 of FIG. 2 is merely exemplary.

As the flared tubular end 100 passes through the housing 64, the flared tubular end 100 contacts the fingers 82 and deflects them by spreading them outward so that the flared tubular end 100 is able to pass into the space within the first annular portion 78 of the clip 66. In this application the term “deflect” refers to strain that is visible with the naked eye, and not the microscopic strain that occurs when any two parts come into contact with each other. The flared tubular end 100 is further inserted to abut the shoulder 86 of the diffuser 67. As the flared tubular end 100 presses against the shoulder 86, the o-ring 69 is compressed.

The flared tubular end 100 passes beyond the ends of the fingers 82 and the fingers 82 are able to pivot inward again. The deflection of the fingers 82 is thus relieved and the ends of the fingers 82 move inward to interfere with withdrawal of the flared tubular end 100 from the quick-connect coupling 26. When the fingers 82 are disposed to block withdrawal of the flared tubular end 100 from the housing 64, the inflation tube 28 has moved from a disengaged position to an engaged position, with respect to the quick-connect coupling 26.

If force is exerted tending to withdraw the inflation tube 28 from the quick-connect coupling 26, the fingers 84 are drawn further inward by pressure from the flared tubular end 100, and the inflation tube 28 is unable to be uncoupled from the quick-connect coupling 26. Additionally, the o-ring 69 continuously presses the flared tubular end 100 against the ends of the fingers 84 so that the ends of the fingers 84 do not rattle against the flared tubular end 100. The quick-connect coupling 26 thus provides “positive locking” coupling because the ends of the fingers 82 snap inward, thereby providing a palpable engagement event that makes it difficult to obtain an improper or incomplete coupling.

The various components of the airbag module 10 may be manufactured and assembled according to a variety of methods. According to one example, the fabric panel(s) of the cushion 11 may be cut via a laser and attached to provide the shapes illustrated in FIG. 1 via sewing, one-piece weaving (OPW), radio frequency (RF) welding, or other methods. The inflator chamber 25, the housing 64, the diffuser 67, and the inflation tube 28 may be manufactured according to known methods such as extrusion, casting, rolling, cold heading, and the like. The clip 66 may be stamped from a-substantially flat expanse of metal, and then rolled to provide a substantially tubular shape. The screen 68 may be obtained from a suitable supplier and cut or compressed to the desired shape.

In order to assemble the airbag module 10, the smaller portion 96 of the inflation tube 28 may be inserted into the inlet port 102 of the remainder of the cushion 11 and the clamp 104 may be applied via crimping or the like to retain the smaller portion 96 within the inlet port 102. The housing 64 may be inertially welded to the inflator chamber 25 and the burst disc 62 may be positioned to cover the indentation 70 as illustrated. The inflator chamber 25 may then be filled with inflation gas. The o-ring 69 may then be inserted into the housing 64, and the diffuser 67 may then be inserted into the housing 64 such that the o-ring 69 is positioned between the shoulders 74, 86 of the housing 64 and the diffuser 67.

The clip 66 may then be compressed to a size that permits it to be inserted into the housing 64 through the opening defined by the retention lip 76. After the clip 66 enters the housing 64, it is permitted to expand so that the retention lip 76 interferes with withdrawal of the clip 66 from the housing 64. The fingers 82 then extend inward to keep the o-ring 69 and the diffuser 67 in place prior to coupling of the inflation tube 28 with the quick-connect coupling 26.

The inflator 24 and the cushion 11 may then be shipped prior to coupling of the quick-connect coupling 26 with the inflation tube 28. The inflator 24 requires no transportation cap because the diffuser 67 disperses inflation gases in a radial, thrust neutral manner. The installer may install either the cushion 11 or the inflator 24 in the vehicle 12 first. The other of the cushion 11 and the inflator 24 may be installed immediately thereafter, or after other, intervening manufacturing steps have been performed. The inflation tube 28 may then be attached to the quick-connect coupling 26 in the manner described previously, and the inflator 24 may be coupled to the ECU 21 via the electric lines 22 shown in FIG. 1 to prepare the airbag module 10 for operation.

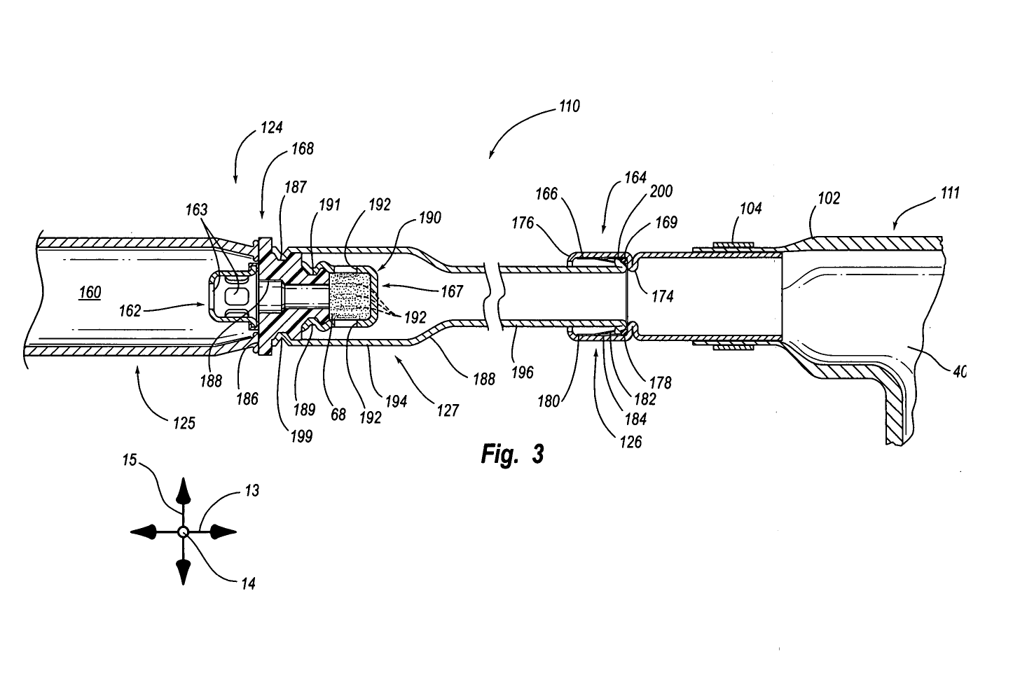

Referring to FIG. 3, a side elevation, section view illustrates an airbag module 110 according to one alternative embodiment of the invention. As shown, the airbag module 110 has a cushion 111, which may have a configuration similar to that of the cushion 11 of the previous embodiment. Additionally, the airbag module 110 has an inflator 124, which may also be a compressed gas, hybrid, or pyrotechnic inflator.

The inflator 124 includes an inflator chamber 124. However, the inflator 124 does not include a quick-connect coupling. Rather, the airbag module 110 includes a quick-connect coupling 126 designed to receive an inflation conduit in the form of a gas guide 127 attached to the inflator 124 in quick-connect fashion. The quick-connect coupling 216 is attached to another inflation conduit, which takes the form of an inflation tube 128 of the cushion 111. As in the previous embodiment, the inflation tube 128 is retained within an inlet port 102 of the cushion 111 via a clamp 104.

The gas guide 127 enables the inflator 124 to be positioned relatively further from the cushion 111. The gas guide 127 may be formed of metal and may be substantially rigid, or may be pliable to facilitate installation of the gas guide 127 at the desired location in a vehicle.

As in the previous embodiment, the inflator chamber 125 has an interior 160. If the inflator 124 is a pure pyrotechnic inflator, no fluid may be present within the interior 160. In place of the burst disc 62 of the previous embodiment, the inflator 124 has an interior baffle 162. The interior baffle 162 has a plurality of orifices 163 through which inflation gas is able to flow to exit the inflator chamber 125. Any pyrotechnic materials used may be sealed from moisture through the use of other seals (not shown).

The quick-connect coupling 126 is configured in a manner somewhat similar to the quick-connect coupling 26 of the previous embodiment. The quick-connect coupling 126 has a housing 164 with a generally tubular shape, and a first retention feature in the form of a clip 166. Since the quick-connect coupling 126 is attached to the inflation tube 128, not to the inflator 124, the quick-connect coupling 126 does not have a diffuser. Rather, the inflator 124 has a diffuser 167 attached to an end plate 168. The end plate 168, in turn, is attached to the gas guide 127 and to the inflator chamber 125 in a manner that will be described subsequently. A screen 68 like that of the previous embodiment is contained within the diffuser 167.

In addition to the housing 164 and the clip 166, the quick-connect coupling 126 also has an o-ring 169. The housing 164, the clip 166, and the o-ring 169 may be shaped generally the same as their counterparts from the previous embodiment. However, they may optionally be smaller than the housing 64, clip 66, and o-ring 69, as illustrated in FIG. 3, to better correspond with the diameter of the inflation tube 128.

The housing 164 may be made as a single piece with the inflation tube 128. More precisely, in place of the shoulder 74 of the housing 64 of the previous embodiment, the housing 164 may be separated from the inflation tube 128 via a bend 174. The housing 164 and the inflation tube 128 may thus be formed from a single metal tube that is crimped or otherwise deformed to provide the bend 174. Like the housing 64, the housing 164 also has a retention lip 176. The clip 166 may be retained between the bend 174 and the retention lip 176. In alternative embodiments, the housing 164 may be formed separately from the inflation tube 128 and attached to the inflation tube 128 via fasteners, welding, or other known methods.

Like the clip 66, the clip 166 has a first annular portion 178 and a second annular portion 180. A plurality of fingers 182 extend generally between the first and second annular portions 178, 180, but extend inward with respect to the axis of symmetry of the inflator 124. The first and second annular portions 178, 180 are connected via connecting portions 184 arrayed between the fingers 182.

The end plate 168 has a shoulder 186 that is fixedly attached to the inflator chamber 125, for example, via inertial welding. The end plate 168 also has a first crimp interface 187 adjacent to the shoulder 186. The first crimp interface 187 is designed to receive one end of the gas guide 127, and may have a circumferential groove or other feature that facilitates retention via crimping. The end plate 168 also has a passageway 188 through which inflation gas is able to travel to exit the inflator chamber 125. Additionally, the end plate 168 has a second crimp interface 189 that also has a circumferential groove or other feature designed to receive one end of the diffuser 167.

The diffuser 167 has an outflow cap 190 and a crimped end 191 that is crimped into engagement with the second crimp interface 189. The outflow cap 190 is positioned to receive inflation gas from the passageway 188 and to disperse the inflation gas in a generally radial, thrust neutral pattern via a plurality of radially-oriented orifices 192. The inflation gas is then conveyed to the cushion 111 via the gas guide 127. The screen 68 is positioned within the outflow cap 190 to prevent solid matter from exiting the inflator 124.

The gas guide 127 has a larger portion 194 adjacent to the inflator 124 and a smaller portion 196 adjacent to the inflation tube 128. The larger portion 194 and the smaller portion 196 are separated from each other by a taper 198. Additionally, the gas guide 127 has a crimped end 199 that is crimped into engagement with the first crimp interface 187 of the end plate 168 of the inflator 124. In alternative embodiments, the gas guide 127 may be attached to the inflator 124 in a variety of ways, or may be integrally formed with the inflator chamber 125.

The gas guide 127 also has a second retention feature in the form of a flared tubular end 200. The flared tubular end 200 is retained by the quick-connect coupling 126 in a manner similar to the corresponding components of the previous embodiment. More precisely, the flared tubular end 200 may first be inserted into the housing 164 such that the flared tubular end 200 abuts the fingers 182 and deflects them, causing them to spread outward. Since the quick-connect coupling 126 does not contain a diffuser, the flared tubular end 200 does not abut a diffuser. Rather, the flared tubular end 200 is moved further into the housing 164 until the flared tubular end 200 compresses the o-ring 169 directly, and passes beyond the ends of the fingers 182.

The deflection of the fingers 182 is relieved as they are able to snap inward again, and the ends of the fingers 182 block withdrawal of the flared tubular end 200 from the housing 164. The o-ring 169 restricts inflation gas leakage from the quick-connect coupling 126 and keeps the flared tubular end 200 snugly pressed against the ends of the fingers 182 to avoid rattling during vehicle operation.

The various components of the airbag module 110 may be manufactured and assembled according to a variety of methods. The inflator chamber 125, the diffuser 167, the clip 166, and the fabric portion of the cushion 111 may be manufactured according to methods similar to those of their counterparts of the previous embodiment. The interior baffle 162 and the end plate 168 may be stamped, cold headed, forged, or otherwise formed of metallic materials. The gas guide 127, inflation tube 128, and housing 164 may also be manufactured according to known methods such as extrusion, casting, rolling, cold heading, and the like. As described previously, the housing 164 and the inflation tube 128 may be manufactured as a single continuous tube. The tube may then be crimped or otherwise deformed to provide the bend 174, thereby separating the housing 164 from the inflation tube 128.

The end of the inflation tube 128 may be fixed within the inlet port 102 of the cushion 111 by the clamp 104 in a manner similar to that of the previous embodiment. The clip 166 may be compressed to fit into the opening defined by the retention lip 176, inserted into the housing 164, and then allowed to expand, and the o-ring 169 may then be inserted into the housing 164. The interior baffle 162 may be welded, brazed, or otherwise attached to the end plate 168, and the end plate 168 may be inertially welded to the inflator chamber 125. The screen 68 is inserted into the outflow cap 190 and the crimped end 191 of the diffuser 167 is crimped into engagement with the second crimp interface 189 of the end plate 186.

The inflator 124, gas guide 127, and cushion 111 with the attached quick-connect coupling 126 may then be shipped-to the vehicle manufacturer as three separate pieces. The vehicle manufacturer may then crimp the crimped end 199 of the gas guide 127 into engagement with the first crimp interface 187 of the end plate 186. Alternatively, the crimped end 199 may be crimped into engagement with the first crimp interface 187 prior to shipping, so that the inflator 124 and the gas guide 127 are shipped in assembled form, and the cushion and the quick-connect coupling 126 are shipped as a separate piece.

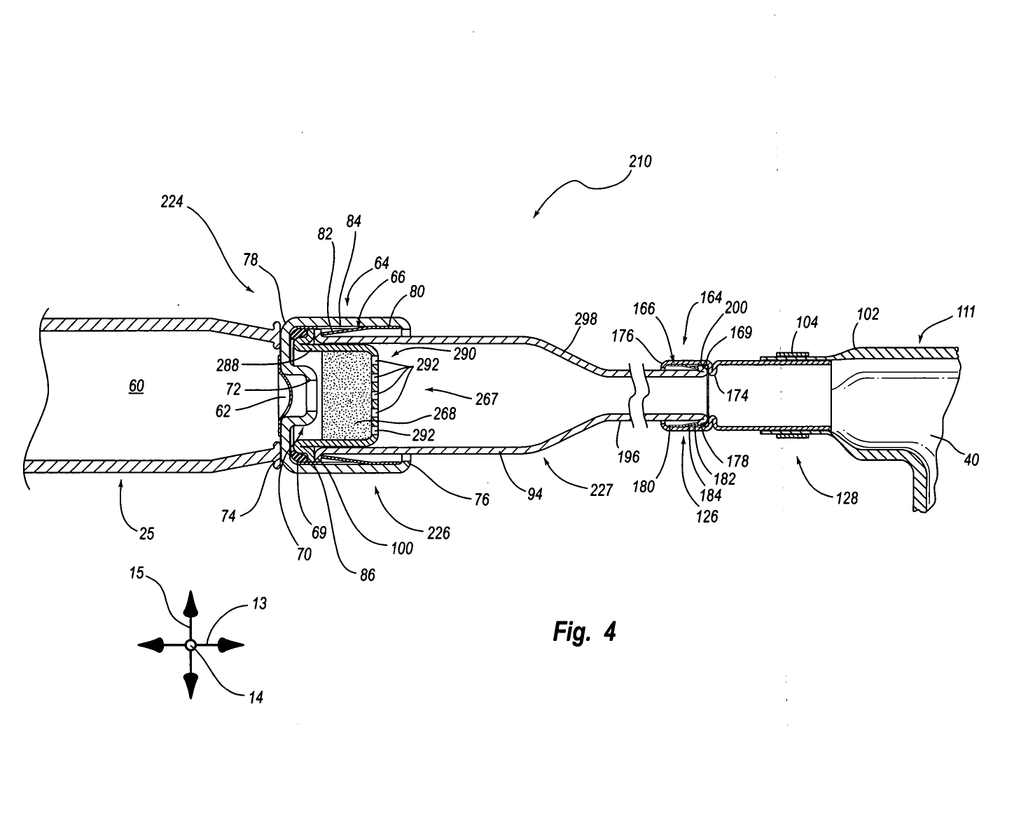

Referring to FIG. 4, a side elevation, section view illustrates an airbag module 210 according to another alternative embodiment of the invention. The airbag module 210 incorporates features of the previous two embodiments to provide two quick-connect couplings for optimal shipping and installation flexibility. The airbag module 210 has a cushion 111 like that of the previous embodiment. Additionally, the airbag module 210 has an inflator 224 slightly different from the inflator 24 of the first embodiment in that the inflator 224 provides axial deployment.

As in the previous embodiment, the cushion 111 has an inflation tube 128 attached directly to the fabric of the cushion 111. The inflation tube 128 is gripped within the inlet port 102 of the cushion 111 by a clamp 104.

The inflator 224 has a gas chamber 25 similar to that of the first embodiment. Additionally, the inflator 224 also has a first quick-connect coupling 226, which is also similar to the quick-connect coupling 26 of the first embodiment. In addition to the cushion 111 and the inflator 224, the airbag module 210 includes an inflation conduit in the form of a gas guide 227 that conveys inflation gas from the inflator 224 to the cushion 111. The gas guide 227 is coupled to a second quick-connect coupling 126, which may be identical to the quick-connect coupling 126 of the previous embodiment. The gas guide 227 is connectable to both of the quick-connect couplings 226, 126 in quick-connect fashion.

As in the first embodiment, the inflator chamber 25 has an interior 60, which may contain a pressurized gas or liquid/gas mixture, a pyrotechnic, or some combination thereof. A burst disc 62 keeps gases within the inflator 224 until deployment occurs. The second quick-connect coupling 226 has a housing 64, a clip 66, a diffuser 267, a screen 268, and an o-ring 69. The housing 64, clip 66, and o-ring 69 are similar to their counterparts of the first embodiment. Thus, the housing 64 has an indentation 70 with an orifice 72, a shoulder 74 attached to the inflator chamber 25, and a retention lip 76. The clip 66 has a first annular portion 78, a second annular portion 80, a plurality of inwardly extending fingers 82, and a plurality of connecting portions 84 arrayed between the fingers 82.

However, the diffuser 267 is not a radial flow, thrust-neutral diffuser, but instead provides axial outflow. The diffuser 267 has a shoulder 86 that cooperates with the interior of the shoulder 74 of the housing 64 to sandwich the o-ring 69. The diffuser 267 also has a passageway 288 through which inflation gas flows from the orifice 72 to an outflow cap 290. As shown, the outflow cap 290 has a plurality of orifices 292 oriented to eject inflation gas from the inflator 224 in a direction generally parallel to the axis of the inflator 224. Accordingly, the inflator 224 provides axial outflow, or axial deployment. The inflation gas flows through the screen 268, which prevents the ejection of solid matter from the inflator 224.

As in the previous embodiment, the second quick-connect coupling 126 has a housing 164, a clip 166, and an o-ring 169. All of these components are configured and assembled in the manner set forth previously, in the description of FIG. 3.

The gas guide 227 has a larger portion 94 like the larger portion 94 of the inflation tube 28 of FIG. 2. Additionally, the gas guide 227 has a smaller portion 196 like the smaller portion 196 of the gas guide 127 of FIG. 3. The larger portion 94 and the smaller portion 196 are connected via a taper 298. The gas guide 227 also has a flared tubular end 100 retained by the first quick-connect coupling 226 and a flared tubular end 200 retained by the second quick-connect coupling 126. The flared tubular ends 100, 200 are retained by the quick-connect couplings 226, 126 by the clips 66, 166 in response to insertion of the flared tubular ends 100, 200 into the housings 64, 164, as set forth previously.

The various components of the airbag module 210 may be manufactured and assembled according to a wide variety of methods. Exemplary manufacturing methods for many of the components of FIG. 4 have been set forth previously. The gas guide 227, diffuser 267, and screen 268 may be obtained or made through the use of any of the methods described in the discussion of the gas guide 127, diffuser 67, and screen 68 of the previous embodiments. The inflator 224 may be assembled in a manner similar to that of the inflator 24, and the cushion 111 may be assembled as described in the discussion of FIG. 3.

The cushion 111, inflator 224, and gas guide 227 are then ready for shipping, and may be transported as three separate pieces. The vehicle manufacturer may install them in any desired order, and may easily couple the gas guide 227 to the cushion 111 and the inflator 224 via the quick-connect couplings 226, 126. Accordingly, the airbag module 210 provides a high degree of installation flexibility. The embodiments of FIGS. 2 through 4 are merely exemplary; with the aid of the present disclosure, those of skill in the art will recognize that a variety of inflation conduits and quick-connect couplings may be used in a wide range of combinations to provide additional embodiments.

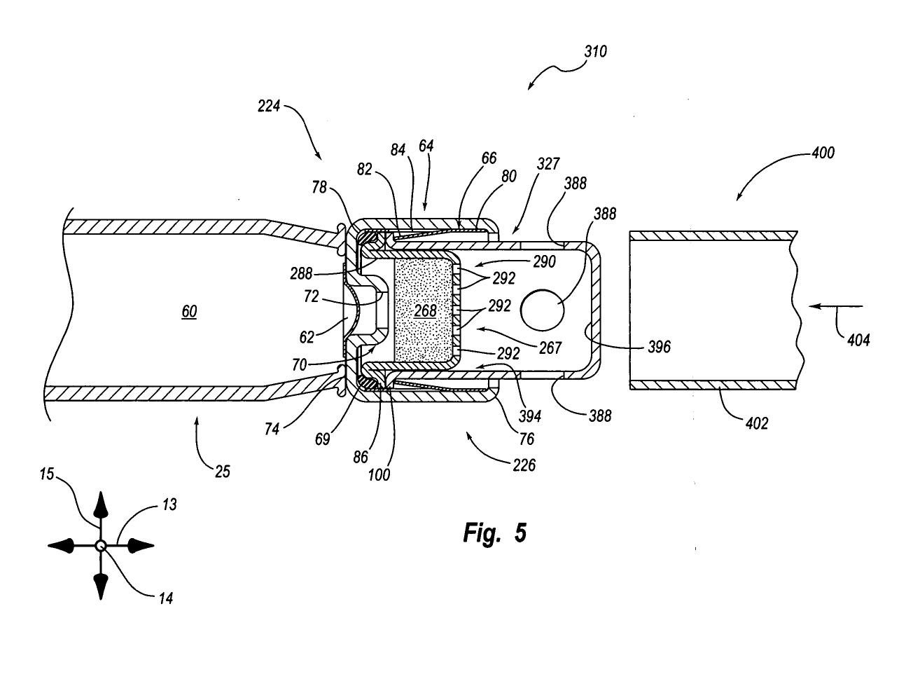

Since the inflator 224 provides axial deployment, it may be advantageous to couple a transportation cap to the inflator 224 prior to shipping to ensure that any inflation gases inadvertently released from the inflator 224 are dispersed in a thrust-neutral manner. The quick-connect coupling 226 of the inflator 224 may be used to receive a transportation cap in quick-connect fashion prior to shipping. The configuration and use of such a transportation cap will be shown and described in greater detail in connection with FIG. 5, as follows.

Referring to FIG. 5, a side elevation, section view illustrates a portion of an inflation assembly 310 including the inflator 224 and a transportation cap 327. The configuration of the inflator 224, including the quick-connect coupling 226, has been set forth previously. The transportation cap 327 has been coupled to the quick-connect coupling 226 to disperse inflation gases in a thrust-neutral manner in the event of accidental deployment.

As shown, the transportation cap 327 has a passageway 394 that encircles the outflow cap 290 of the diffuser 267 to receive inflation gas from the orifices 292. The transportation cap 327 also has an end wall 396 that is substantially solid to keep inflation gases from exiting the inflator 224 in a direction parallel to the axis of the inflator 224. The passageway 394 has a plurality of orifices 398 arranged to eject the inflation gas radially, so that in the event of accidental deployment during transit, the inflator 224 is not subject to significant thrust. The transportation cap 327 has a second retention feature in the form of a flared tubular end 100, like that of the gas guide 227 of the embodiment of FIG. 4.

Thus, the transportation cap 327 may be coupled to the quick-connect coupling 226 in a manner similar to that of the gas guide 227. More precisely, the flared tubular end 100 may be inserted through the opening defined by the retention lip 76, and may contact and deflect the fingers 82 outward. Upon further longitudinal motion of the transportation cap 327, the flared tubular end 100 abuts the shoulder 86 of the diffuser 267, compresses the o-ring 69, and permits the ends of the fingers 82 to snap back inward. The transportation cap 327 is then positively locked via the quick-connect coupling, and the o-ring 69 restricts inflation gas from exiting the inflator 224 by any path other than through the orifices 398.

After the inflation assembly 310 has been transported to its desired destination, the transportation cap 327 may be easily removed from the inflator 224 through the use of a removal tool 400. According to one embodiment, the removal tool 400 has an annular shaft 402 sized to slide longitudinally, along a direction indicated by an arrow 404, around the exterior of the transportation cap 327 (except for the shoulder 86) and into the opening defined by the retention lip 76. The removal tool 400 may have a handle or other implement (not shown) that facilitates gripping of the removal tool 400 to remove the transportation cap 327.

As the annular shaft 42 passes into the interior of the housing 64, the annular shaft 402 abuts the fingers 82 and causes them to deflect outward. Once the ends of the fingers 82 have moved outward far enough that they no longer block withdrawal of the flared tubular end 100, the transportation cap 327 moves from an engaged position to a disengaged position as the flared tubular end 100 moves toward the removal tool 400 in response to the pressure of the compressed o-ring 69. The flared tubular end 100 passes the ends of the fingers 82, and the transportation cap 327 may easily be withdrawn from the housing 64, for example, by hand.

The annular shaft 402 may be removed prior to removal of the transportation cap 327. Alternatively, the annular shaft 402 may fit around the transportation cap 327 with a small amount of interference, so that when the annular shaft 402 is withdrawn from the housing 64, the transportation cap 327 is simultaneously withdrawn.

If desired, the inflation tube 28, gas guide 127, or gas guide 227 may be removed from their corresponding quick-connect couplings 26, 126, 226 through the use of a tool (not shown) similar to the removal tool 400. Such a tool may have two half-tubular segments that can be locked together around the inflation tube 28, gas guide 127, or gas guide 227 and then inserted into the corresponding quick-connect coupling 26, 126, 226 to disengage the inflation tube 28, gas guide 127, or gas guide 227 in a manner similar to that of the removal tool 400.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An airbag module for protecting an occupant of a vehicle from impact, the airbag module comprising:
an inflator chamber that releases inflation gas in response to receipt of an activation signal;
a cushion shaped to receive the inflation gas to enable inflation of the cushion to provide impact protection;
a first retention feature coupled to one of the inflator chamber and the cushion; and
an inflation conduit comprising a second retention feature movable relative to the first retention feature from a disengaged position to an engaged position in which deflection of one of the retention members occurs and is at least partially relieved, thereby causing the retention members to interlock with each other such that the inflation conduit is positioned to convey the inflation gas from the inflator chamber to the cushion.

2. The airbag module of claim 1, further comprising a housing coupled to one of the inflator chamber and the cushion, the housing having an annular shape, wherein the first retention feature comprises a clip seated in the housing.

3. The airbag module of claim 2, wherein the clip comprises a generally tubular shape with a plurality of inwardly extending fingers, wherein the deflection comprises outward bending of the fingers, wherein the second retention feature comprises a flared tubular end, wherein relief of the deflection comprises permitting ends of the fingers to move inward to abut the flared tubular end to restrict withdrawal of the flared tubular end from the housing.

4. The airbag module of claim 3, further comprising an o-ring compressed between the flared tubular end and an interior surface of the housing in the engaged position to restrict inflation gas leakage out of the housing.

5. The airbag module of claim 3, wherein the first retention feature is coupled to the inflator chamber, wherein the inflation conduit is selected from the group consisting of an inflation tube attached directly to a fabric of which the cushion is generally constructed, and a gas guide connectable to the inflation tube.

6. The airbag module of claim 5, further comprising a diffuser oriented to eject inflation gas along an axis of the inflator chamber and into the housing, wherein the diffuser is movable within the housing and is biased toward the first retention feature by an o-ring to press the flared tubular end against the ends of the fingers.

7. The airbag module of claim 5, wherein the first retention feature is also interlockable with a flared tubular end of a transportation cap shaped to disperse inflation gas from the inflator in a substantially thrust-neutral pattern, wherein the fingers are deflectable in response to insertion of an annular shaft of a removal tool into the housing to permit removal of the transportation cap from the inflator chamber.

8. The airbag module of claim 3, wherein the first retention feature is coupled to an inflation tube attached directly to a fabric of which the cushion is generally constructed, wherein the inflation conduit is coupled to the inflator chamber.

9. A component of an airbag module for protecting an occupant of a vehicle from impact, the component comprising:
a first structure selected from the group consisting of an inflator chamber that releases inflation gas in response to receipt of an activation signal, and a cushion shaped to be inflatable to provide impact protection; and
a first retention feature coupled to the first structure, wherein the retention feature is deflectable to interlock with a second retention feature of a second structure selected from the group consisting of an inflation conduit shaped to convey inflation gas, and a transportation cap shaped to disperse gas in a substantially thrust-neutral pattern.

10. The component of claim 9, further comprising a housing coupled to the first structure, the housing having an annular shape, wherein the first retention feature comprises a clip seated in the housing.

11. The component of claim 10, wherein the clip comprises a generally tubular shape with a plurality of inwardly extending fingers, wherein the deflection comprises outward bending of the fingers, wherein the second retention feature comprises a flared tubular end, wherein relief of the deflection comprises permitting ends of the fingers to move inward to abut the flared tubular end to restrict withdrawal of the flared tubular end from the housing.

12. The component of claim 11, further comprising an o-ring compressible between the flared tubular end and an interior surface of the housing to restrict inflation gas leakage out of the housing.

13. The component of claim 11, wherein the first structure comprises an inflator chamber that releases inflation gas in response to receipt of an activation signal.

14. The component of claim 13, wherein the second structure comprises an inflation conduit shaped to convey inflation gas to a cushion shaped to be inflatable to provide impact protection, wherein the inflation conduit is selected from the group consisting of an inflation tube attached directly to a fabric of which the cushion is generally constructed and a gas guide connectable to the inflation tube.

15. The component of claim 13, wherein the second structure comprises a transportation cap, the second retention feature comprising a flared tubular end of the transportation cap, wherein the transportation cap is shaped to disperse inflation gas from the inflator in a substantially thrust-neutral pattern and the fingers are deflectable in response to insertion of an annular shaft of a removal tool into the housing to permit removal of the transportation cap from the inflator chamber.

16. The component of claim 13, further comprising a diffuser oriented to eject inflation gas along an axis of the inflator chamber and into the housing, wherein the diffuser is movable within the housing and is biased toward the first retention feature by an o-ring to press the flared tubular end against the ends of the fingers.

17. The component of claim 11, wherein the first structure comprises a cushion shaped to be inflatable to provide impact protection, wherein the first retention feature is coupled to an inflation tube attached directly to a fabric of which the cushion is generally constructed, wherein the second structure comprises an inflation conduit shaped to convey inflation gas from an inflator chamber to the cushion.

18. An inflation assembly connectable to a cushion to form an airbag module for protecting an occupant of a vehicle from impact, the inflation assembly comprising:
an inflator comprising an inflator chamber that releases inflation gas in response to receipt of an activation signal, and a first retention feature coupled to the inflator chamber; and
a transportation cap comprising a second retention feature movable relative to the first retention feature from a disengaged position to an engaged position in which deflection of one of the retention members occurs and is at least partially relieved to interlock the retention members with each other such that the transportation cap is positioned to disperse inflation gas released form the inflator in a substantially thrust-neutral pattern.

19. The inflation assembly of claim 18, wherein the inflator further comprises a housing coupled to the inflator chamber, the housing having an annular shape, wherein the first retention feature comprises a clip seated in the housing.

20. The inflation assembly of claim 19, wherein the clip comprises a generally tubular shape with a plurality of inwardly extending fingers, wherein the deflection comprises outward bending of the fingers, wherein the second retention feature comprises a flared tubular end, wherein relief of the deflection comprises permitting ends of the fingers to move inward to abut the flared tubular end to restrict withdrawal of the flared tubular end from the housing.

21. The inflation assembly of claim 20, further comprising an o-ring compressed between the flared tubular end and an interior surface of the housing in the engaged position to restrict inflation gas leakage out of the housing.

22. The inflation assembly of claim 21, wherein the inflator further comprises a diffuser oriented to eject inflation gas along an axis of the inflator and into the housing, wherein the diffuser is movable within the housing and is biased toward the first retention feature by the o-ring to press the flared tubular end against the ends of the fingers.

23. The inflation assembly of claim 22, wherein the fingers are deflectable in response to insertion of an annular shaft of a removal tool into the housing to permit removal of the transportation cap from the inflator chamber.

24. A method for assembling an airbag module for protecting an occupant of a vehicle from impact, the airbag module comprising an inflator chamber, a cushion, a first retention feature, and an inflation conduit, the method comprising:
moving the second retention feature relative to the first retention feature from a disengaged position to deflect one of the retention members, wherein the inflator chamber is able to release inflation gas in response to receipt of an activation signal, the cushion is inflatable to provide impact protection, and the first retention feature is coupled-to one of the inflator chamber and the cushion; and
further moving the second retention feature relative to the first retention feature to an engaged position in which the deflection is at least partially relieved, thereby causing the retention members to interlock with each other such that the inflation conduit is positioned to convey the inflation gas from the inflator chamber to the cushion.

25. The method of claim 24, wherein the airbag module further comprises a housing coupled to one of the inflator chamber and the cushion, the housing having an annular shape, wherein the first retention feature comprises a clip seated in the housing, the method further comprising inserting the second retention feature into the housing to contact the first retention feature with the second retention feature.

26. The method of claim 25, wherein the clip comprises a generally tubular shape with a plurality of inwardly extending fingers and the second retention feature comprises a flared tubular end, wherein deflecting one of the retention members comprises bending the fingers outward, wherein at least partially relieving the deflection comprises permitting ends of the fingers to move inward to abut the flared tubular end to restrict withdrawal of the flared tubular end from the housing.

27. The method of claim 26, wherein the airbag module further comprises an o-ring, wherein further moving the second retention feature relative to the first retention feature comprises compressing the o-ring between the flared tubular end and an interior surface of the housing in the engaged position to restrict inflation gas leakage out of the housing.

28. The method of claim 26, wherein the first retention feature is coupled to the inflator chamber, wherein the inflation conduit is selected from the group consisting of an inflation tube attached directly to a fabric of which the cushion is generally constructed, and a gas guide connectable to the inflation tube, the airbag module further comprising a diffuser oriented to eject inflation gas along an axis of the inflator chamber and into the housing, wherein further moving the second retention feature relative to the first retention feature comprises pressing the flared tubular end against the diffuser to compress an o-ring such that the o-ring biases the flared tubular end against the ends of the fingers.

29. The method of claim 26, wherein the first retention feature is coupled to the inflator chamber, wherein the inflation conduit is selected from the group consisting of an inflation tube attached directly to a fabric of which the cushion is generally constructed, and a gas guide connectable to the inflation tube, wherein the first retention feature is also interlockable with a flared tubular end of a transportation cap shaped to disperse inflation gas from the inflator in a substantially thrust-neutral pattern, the method further comprising inserting an annular shaft of a removal tool into the housing to bend the fingers outward, thereby permitting removal of the transportation cap from the inflator chamber.

30. The method of claim 26, wherein the first retention feature is coupled to an inflation tube attached directly to a fabric of which the cushion is generally constructed, the method further comprising coupling the inflation conduit to the inflator chamber.

31. A method for assembling an inflation assembly connectable to a cushion to form an airbag module for protecting an occupant of a vehicle from impact, the inflation assembly comprising an inflator having an inflator chamber and a first retention feature, and a transportation cap having a second retention feature, the method comprising:
moving the second retention feature relative to the first retention feature from a disengaged position to deflect one of the retention members, wherein the inflator chamber is able to release inflation gas in response to receipt of an activation signal and the-first retention feature is coupled to the inflator chamber; and
further moving the second retention feature relative to the first retention feature to an engaged position in which the deflection is at least partially relieved, thereby causing the retention members to interlock with each other such that the transportation cap is positioned to disperse inflation gas released form the inflator in a substantially thrust-neutral pattern.

32. The method of claim 31, wherein the inflator further comprises a housing coupled to one of the inflator chamber and the cushion, the housing having an annular shape, wherein the first retention feature comprises a clip seated in the housing, the method further comprising inserting the second retention feature into the housing to contact the first retention feature with the second retention feature.

33. The method of claim 32, wherein the clip comprises a generally tubular shape with a plurality of inwardly extending fingers and the second retention feature comprises a flared tubular end, wherein deflecting one of the retention members comprises bending the fingers outward, wherein at least partially relieving the deflection comprises permitting ends of the fingers to move inward to abut the flared tubular end to restrict withdrawal of the flared tubular end from the housing.

34. The method of claim 33, wherein the inflator further comprises an o-ring, wherein further moving the second retention feature relative to the first retention feature comprises compressing the o-ring between the flared tubular end and an interior surface of the housing to restrict inflation gas leakage out of the housing.

35. The method of claim 34, wherein the inflator further comprises a diffuser oriented to eject inflation gas along an axis of the inflator and into the housing, wherein further moving the second retention feature relative to the first retention feature comprises pressing the flared tubular end against the diffuser to compress the o-ring such that the o-ring biases the flared tubular end against the ends of the fingers.
